(19) United States
(12) Patent Application Publication
(10) Pub. No.: US 2001/0005498 A1
(43) Pub. Date: Jun. 28, 2001

(54) Device for the selective catalytic oxidation of carbon monoxide

(76) Inventors: Uwe Benz, Uhldingen-Muhlhof (DE); Alexandra Hassert, Wangen (DE); Marco Lippert, Bibertal-Buhl (DE); Martin Schafer, Kirchheim/Teck (DE); Martin Schussler, Ulm (DE); Barbara Strobel, Dornstadt (DE); Mantred Strohmaier, Kirchheim/Teck-Jesingen (DE); Alexander Suss, Owen (DE); Frank Sussemilch, Kirchheim (DE); Matthias Wolfsteiner, Kirchheim (DE); Detlef Zur Megede, Kirchheim/Teck (DE)

Correspondence Address: Evenson, McKeown, Edwards & Lenahan, P.L.L.C., Suite 700, 1200 G Street, N.W., Washington, DC, 20005, US

(21) Appl. No.: 09/728,485

(22) Filed: Dec. 4, 2000

(30) Foreign Application Priority Data
Dec. 3, 1999 (DE) 199 58 404.4

(51) Int. Cl. C01B 31/20

(52) U.S. Cl. 423/247; 423/437.2; 422/189

(57) ABSTRACT

A multistage device for the selective catalytic oxidation of carbon monoxide contained in a hydrogen-rich gas-mixture stream includes at least three stages, each stage having at least one CO oxidation chamber. An oxidizing medium may be metered to an inlet side of each stage. A common cooling device is provided for the first two stages and an independent cooling device is provided for the third stage.

### BACKGROUND AND SUMMARY OF INVENTION

This application claims the priority of German patent document 199 58 404.4, filed Dec. 3, 1999, the disclosure of which is expressly incorporated by reference herein.

The present invention relates to a device for the selective catalytic oxidation of carbon monoxide.

DE 195 44 895 C1 discloses a method and a device for the selective catalytic oxidation of carbon monoxide. In that document, it is proposed for the oxidizing gas to be introduced at a plurality of points along the gas-mixture flow path with in each case a controlled through-flow quantity. Moreover, it is proposed for the gas-mixture stream to be passively cooled by static mixer structures arranged in the inlet region of the CO oxidation reactor. This possibility of influencing the exothermic CO oxidation along the path through the reactor enables the process control to be adapted to a particular situation. A preferred use involves obtaining hydrogen by reforming methanol for motor vehicles, which are driven by a fuel cell.

The present invention is based on the object of providing a device which allows optimum utilization of the available thermal energy in the system and is suitable for dynamic use in a vehicle driven by fuel cell means.

According to the present invention, the device has at least three cooled stages for CO oxidation. A common cooling device is provided for the first two stages and an independent cooling device is provided for the third stage. In this device, the third stage is designed as a combination reactor in which a reaction chamber for CO oxidation and a cooling chamber for the reforming of a hydrogen-rich medium are provided.

Preferably, the first two stages are designed as coated heat exchangers. The advantage is that in the first two stages the process takes place at a relatively high temperature level, so that the thermal energy obtained can be utilized further on in the system, preferably for evaporators and/or reformers. In addition, the mass of catalyst required for the CO removal can be reduced, since the region where the temperatures are high is distinguished by a high chemical activity.

Preferably, an uncooled fourth stage is additionally provided, which may be designed as a tubular reactor.

It is particularly advantageous for a heat exchanger to be arranged between the second and third stages. This heat exchanger can be used to set the temperature at which the CO-containing, hydrogen-rich gas mixture enters the third stage.

It is advantageous to provide a flow of medium which already occurs in the system as the heat-transfer medium for the heat exchanger between the second and third stages.

In a configuration according to the present invention, control means are provided for the metering of an oxidizing medium in all the stages.

In an additional embodiment according to the present invention, control means are provided for the metering of the oxidizing medium in the first three stages, while in the fourth stage the oxidizing medium can be metered passively via a bypass line.

The arrangement according to the present invention offers the advantage that the individual stages can be of very compact, space-saving and inexpensive structure. Thermal energy which is obtained during the cooling of the stages can be utilized in other ways in the fuel cell system, so that the efficiency of the fuel cell system is improved. Furthermore, a multistage arrangement, in particular the preferred uncooled fourth stage, enables the purity of the hydrogen-rich gas mixture to be improved even in dynamic operation.

The present invention is particularly suitable for fuel cell systems which are used in vehicles.

In a vehicle which is driven by a fuel cell with mobile gas generation, hydrogen-rich reformate is formed with a CO content which is not tolerated by the fuel cell, since the catalytic converters used are rendered unusable by the CO content.

Before the reformate can be fed to the fuel cell, the CO has, as far as possible, to be selectively removed from the reformate. In the process, the energy balance of the system should preferably be optimized in such a way that the minimum possible amount of heat is lost.

The reaction for the CO removal is strongly exothermic, so that large amounts of waste heat are produced.

According to the present invention, an at least three-stage gas-cleaning system is proposed, which is of very compact structure and results in an advantageously space-saving gas-cleaning system which can be used to particularly good effect in a vehicle which is operated by a fuel cell.

A preferred system has four stages for CO removal. If the demands imposed on the dynamics of the system are not high, it is possible to dispense with the fourth stage.

Other objects, advantages and novel features of the present invention will become apparent from the following detailed description of the invention when considered in conjunction with the accompanying drawings.

### BRIEF DESCRIPTION OF THE DRAWING

FIG. 1 illustrates a four-stage gas-cleaning system according to the present invention; and

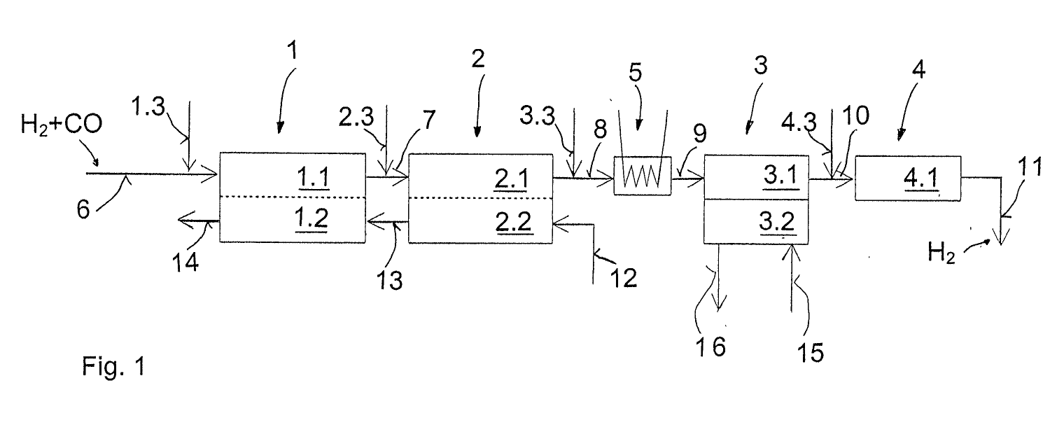

FIG. 2 shows a gas-cleaning system with a bypass line for the fourth stage.

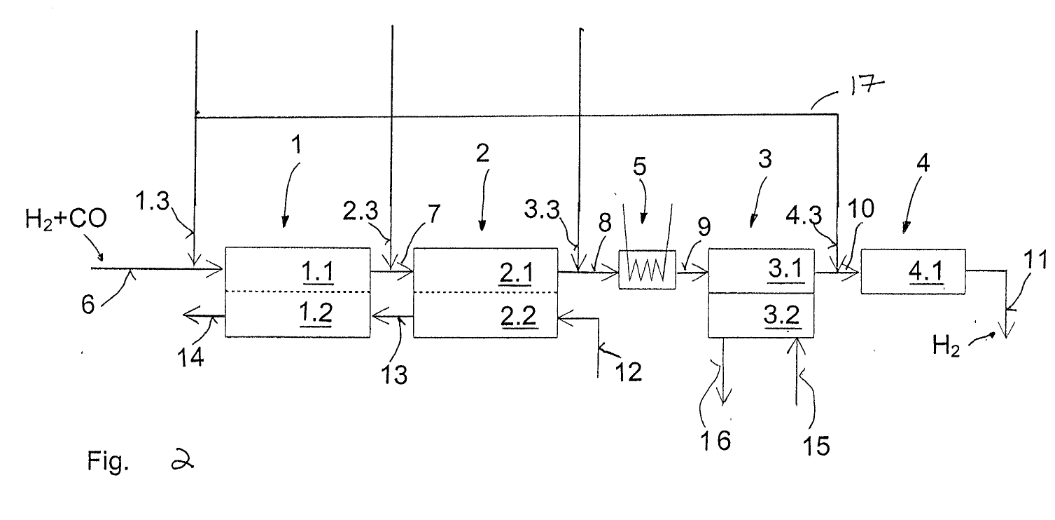

### DETAILED DESCRIPTION OF THE DRAWING

A first stage 1 has a CO oxidation unit 1.1 and a cooling device 1.2; a second stage 2 has a CO oxidation unit 2.1 and a cooling device 2.2; a third stage 3 has a CO oxidation unit 3.1 and a cooling device 3.2; and a fourth stage 4 has a CO oxidation unit 4.1. A heat exchanger 5 is provided between the second and third stages 2, 3.

A hydrogen-rich, CO-contaminated reformate, referred to below as H₂+CO, which is generated in a reformer (not shown), is introduced to the inlet of the first stage 1 via a feed line 6 and is then passed from the outlet of the first stage 1 via line 7 to the inlet of the second stage 2, from the outlet of the second stage 2 via line 8 to the inlet of the heat exchanger 5, from the outlet of the heat exchanger 5 via line 9 to the inlet of the third stage 3, from the outlet of the third stage 3 via line 10 to the inlet of the fourth stage 4 and, from the outlet of the fourth stage 4, as purified gas H₂, via line 11 to a fuel cell (not shown).

Each of the four stages 1, 2, 3, 4 has a metering device for supplying an oxidizing medium, for example air. A metering device 1.3 is arranged upstream of the first stage 1; a metering device 2.3 is arranged upstream of the second stage 2; a metering device 3.3 is arranged upstream of the third stage 3; and a metering device 4.3 is arranged upstream of the fourth stage 4.

Stage 1 and Stage 2 are connected to a common cooling circuit (12, 2.2, 13, 1.2, 14). A cooling medium is fed in a line 12 to the inlet of the cooling device 2.2 of the second stage 2; is passed from the outlet of the cooling chamber 2.2 of the second stage 2 via a line 13 to the inlet of the cooling device 1.2 of the first stage 1; and is discharged through the outlet of the cooling device 1.2 from the first stage 1 via a line 14. The cooling medium flows through the cooling circuit (12, 2.2, 13, 1.2, 14) in countercurrent to the reformate H₂+CO.

Preferably, the first two stages 1, 2 are each composed of a catalytically coated heat exchanger as CO oxidation unit 1.1, 2.1 and a common cooling circuit comprising cooling chambers 1.2, 2.2 through which a heat-transfer oil flows. The temperature of the heat-transfer oil is preferably between 200° C. and 350° C., more preferably between 250° C. and 300° C. The CO oxidation units 1.1, 2.1 of the two stages 1, 2 are expediently designed as plate reactors which are coated with a precious metal catalyst, preferably platinum.

The third stage 3 is preferably designed as a combination reactor in which the CO oxidation unit 3.1 is coupled to the cooling device 3.2. The cooling device 3.2 is independent of the cooling device for the first two stages 1, 2.

Reaction chambers and cooling chambers in the third stage 3 are expediently formed by tubes and/or plate chambers running in parallel.

The cooling device 3.2 is preferably a reformer in which an endothermic reaction takes place, which is assisted by the waste heat from the exothermic CO oxidation in 3.1. The cooling medium flows via a line 15 into the cooling device 3.2 and leaves via a line 16. In this case, the cooling medium flows in the opposite direction to the reformate H₂+CO. The line 16 may be expediently directly or indirectly connected to the line 6. The cooling device 3.2 then functions as a reformer connected upstream of the device.

Further suitable cooling media for the cooling device 3.2 of the third stage 3 are other gaseous and/or liquid media, including water, a water/glycol mixture, air, cathode off-gas, anode off-gas, and other media which already occur in the fuel cell system and are suitable for taking up sufficient amounts of thermal energy.

It is preferable to use a precious metal catalyst material, particularly preferably platinum, as heat-transfer surfaces of the arrangement being coated and/or mixing elements, such as braided fabrics, nonwovens, pellets and the like which are impregnated and/or coated with catalyst.

The CO oxidation unit 3.1 of the third stage 3 is preferably designed in plate form. However, it is also possible to use tubes which are guided in parallel and are filled with catalyst-coated mixing elements. To be cooled, these tubes expediently have tubes, preferably of smaller diameter, wound around them and, if appropriate, soldered to them. It is advantageously possible to use copper tubes for this cooling arrangement 3.2.

In the preferred arrangement shown in the figure, the fourth stage 4 is uncooled. However, it is also possible to cool the fourth stage 4. If the demands imposed on the dynamics of the fuel cell system are not high, it is also possible to dispense with the fourth stage 4.

The fourth stage 4 is advantageously designed as a tubular reactor which is filled with coated mixing elements. A catalyst which contains precious metal is advantageous.

In the heat exchanger 5 between the second stage 2 and the third stage 3 it is expedient to use a heat-transfer medium which is formed by a flow of medium that already occurs in the fuel cell system and is at a suitable temperature level. The entry temperature of the reformate H₂+CO which has undergone preliminary purification can be set with the aid of the heat exchanger 5. The heat exchanger is usually an intercooler for further reducing the entry temperature.

The heat exchanger 5 may optionally also be dispensed with if the system is suitably designed or configured and/or according to the demands on the third stage 3.

The metering of the oxidizing medium into the individual stages 1, 2, 3, 4 does not have to take place into the feed lines 6, 7, 8, 9, 10, but rather may also take place directly into the CO oxidation units 1.1, 2.1, 3.1, 4.1 of the stages 1, 2, 3, 4.

In an advantageous configuration of the arrangement, the oxidizing medium may also be metered in by an integrated metering device, in which case in the first stage 1 there is a metering arrangement for the second stage 2 and/or in the second stage 2 there is a metering arrangement for the third stage 3 and/or in the third stage 3 there is a metering arrangement for the fourth stage 4. The oxidizing medium, preferably oxygen, for the stage which in each case follows a preceding stage is preferably introduced with the aid of a probe into an outlet channel for the gas-mixture stream from the preceding stage. In the most simple case, the probe is designed as a tubular line of any desired cross section. Since the oxidizing medium is introduced into the outlet channel from the preceding stage, it is not available for the reaction in this preceding stage. Rather, the oxidizing medium can be mixed with the gas-mixture stream from the preceding stage within this outlet channel. Since the outlet channel from the preceding stage at the same time serves as a feed channel for the following stage, a homogeneous reformate/oxygen mixture is thus fed to the reaction chamber(s) of the following stage. It is therefore possible to dispense with additional external mixing or dispersion structures.

If sufficient capacity is available, it is expedient to provide a control means for each of the metering devices 1.3, 2.3, 3.3, 4.3, in order to regulate the addition of the oxidizing medium to the stages 1, 2, 3, 4. To save capacity, it is also possible to provide means for controlling the metering devices 1.3, 2.3, 3.3 and for the metering 4.3 into the fourth stage 4 to take place via a bypass line 17, in which case the amount of medium metered in is set passively.

The reformate cleaning in the first two stages 1, 2 takes place at a relatively high temperature of between 200° C. and 350° C., preferably between 250° C. and 300° C. The thermal energy obtained can be utilized further in other components of the fuel cell system, such as for example the evaporator and/or reformer. Since the chemical activity is greater at higher temperatures than at lower temperatures, it is possible to save on catalyst material. The arrangement can be of very compact structure. If gaseous cooling media are used in the third stage 3, it is also possible for the thermal energy obtained therein to be utilized in further components of the fuel cell system.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A multistage device for selective catalytic oxidation of carbon monoxide contained in a hydrogen-rich gas-mixture stream, comprising:
at least three cooled stages for carbon monoxide oxidation;
a common cooling circuit for a first stage and a second stage; and
an independent cooling device for a third stage, wherein the cooling device is a cooling chamber for reforming a hydrogen-containing medium.

2. A device according to claim 1, wherein the first and second stages are coated heat exchangers, and wherein the common cooling circuit is an oil circuit.

3. A device according to claim 1, wherein the third stage is a combination reactor comprising a carbon monoxide oxidation chamber and the cooling chamber.

4. A device according to claim 1, further comprising an uncooled fourth stage.

5. A device according to claim 1, further comprising a heat exchanger between the second stage and the third stage.

6. A device according to claim 5, wherein a medium for the heat exchanger is a flow of that already occurs in the device.

7. A device according to claim 1, further comprising control means for metering an oxidizing medium in each stage.

8. A device according to claim 1, further comprising:
control means for metering an oxidizing medium in the first three stages; and
a bypass line for passively metering the oxidizing medium to the fourth stage.

9. A device according to claim 1, wherein at least one of the first or second stage is in plate form.

10. A device according to claim 1, wherein at least one of the third or a fourth stage is a tubular reactor.

11. A process for selective catalytic oxidation of carbon monoxide contained in a hydrogen-rich gas-mixture stream, comprising:
feeding a hydrogen-rich gas stream to a first stage for carbon monoxide oxidation;
feeding a hydrogen-rich gas stream having reduced carbon monoxide from the first stage to a second stage for additional carbon monoxide oxidation;
cooling the first stage and the second stage via a common cooling circuit; and
feeding a hydrogen-rich gas stream having reduced carbon monoxide from the second stage to a third stage for additional carbon monoxide oxidation;
cooling the third stage via an independent cooling device, wherein the cooling device is a reformer.

12. A process according to claim 11, wherein the cooling of the third stage is to a temperature of less than 200° C.
